(19) United States
(12) Patent Application Publication
(10) Pub. No.: US 2015/0248639 A1
(43) Pub. Date: Sep. 3, 2015

(54) DETERMINING OPTIMAL ROUTES AND RATES FOR CARGO TRANSPORTATION

(71) Applicant: SynchroNet Logistics, Inc., Pleasanton, CA (US)

(72) Inventors: Bryan Maney, Rocklin, CA (US); Michael Mitchell, San Antonio, TX (US); Chris Varga, Moyock, NY (US)

(73) Assignee: SynchroNet Logistics, Inc., Pleasanton, CA (US)

(21) Appl. No.: 14/546,694

(22) Filed: Nov. 18, 2014

Related U.S. Application Data
(60) Provisional application No. 62/051,248, filed on Sep. 16, 2014.
(60) Provisional application No. 61/946,624, filed on Feb. 28, 2014.

(51) Int. Cl. G06Q 10/08; G01C 21/00

(52) U.S. Cl. CPC G06Q 10/08345; G01C 21/00

(57) ABSTRACT

Provided are computer systems, methods, and non-transitory computer-readable medium configured for determining optimal routes and rates for cargos transportation between an origin location and a destination location, which determination takes into consideration available truck services from the origin to an origin rail ramp, rail services from the origin rail ramp to a destination rail ramp, and truck services from the destination rail ramp to the destination, along with location of empty containers as well as rates and incentives provided by each vendor.

### CROSS-REFERENCE TO RELATED APPLICATIONS

The present application claims the benefit of U.S. Provisional Patent Application Ser. No. 62/051,248, filed Sep. 16, 2014 and entitled “Determining Optimal Routes and Rates for Cargo Transportation” and 61/946,624, filed Feb. 28, 2014 and entitled “Systems and Methods to Determine Optimal Routes and Rates for Cargo Transportation,” which are both incorporated by reference herein.

### BACKGROUND

In recent decades, the transportation industry has evolved to rely heavily on the use of standardized, modular containers for shipping cargo. The ubiquitous twenty- and forty-foot boxes can be carried on ships, trains, or trucks, and transferred quickly and safely from one transportation mode to another at suitably equipped depots or terminals: hence the term intermodal transportation. Typically, an intermodal marketing company (IMC) mediates between transportation service providers (shipping lines, truckers, rail operators, and the like) and beneficial cargo owners (BCO)—companies who have freight to be moved—providing logistical support and often containers.

Rail transport is especially well suited to containerized shipping, as rail cars can be made in the appropriate size to hold standard containers securely; this arrangement combines the long-haul efficiency of rail transport with the flexibility of intermodal operations. Especially for heavier cargo, the smaller International Standards Organization (ISO)-standard containers can be loaded more efficiently, without the slack space and consequent overweight risk of the larger standard truck trailer. Further, a growing segment of the domestic transportation market comprises stack train operators. Stack trains carry standard-size containers on recessed flatcars, designed to carry them at two levels while maintaining sufficient overhead clearance for bridges and overpasses.

Rail transportation, however, has the disadvantage of being limited to locations where there is long-haul rail access. Pickup and delivery of cargo in other places is normally handled by truck; truck operators transport goods from a “street” location to an intermodal rail terminal (known in the industry as a “ramp”), where they are loaded onto a train and hauled to another ramp near the final destination. There, another trucker takes charge of the containers and delivers them to the final destination to be emptied, mounting them on wheeled chassis that are often hired at the terminal. A cargo booking from one rail terminal to another is known as a ramp-to-ramp move; those that include truck transportation are referred to as door-to-ramp, ramp-to-door, and door-to-door arrangements.

### SUMMARY

The present disclosure describes a Cooperative Access System (CAS) to broker transportation arrangements and equipment between intermodal marketing companies (IMCs), beneficial cargo owners (BCOs), and transportation vendors for domestic rail carriage. Also provided is a rate optimizer that enables operators and customers to locate and calculate the most advantageous and up-to-date rates available for a move on a specific lane, taking into account all variable factors that contribute to those rates.

The present disclosure provides computer systems, methods, and non-transitory computer-readable media configured for determining optimal routes and rates for cargos transportation between an origin location and a destination location, which determination takes into consideration available truck services from the origin to an origin rail ramp, rail services from the origin rail ramp to a destination rail ramp, and truck services from the destination rail ramp to the destination, along with location of empty containers as well as rates and incentives provided by each vendor.

In one implementation, the present disclosure provides a system comprising a processor, a memory and program code which, when executed by the processor, configures the system to: (a) receive a search query comprising an origin, a destination, a description of goods to be transported from the origin to the destination, and a desired time for the transportation; (b) using the search query, search a database comprising information regarding (i) one or more origin vendors providing truck service from the origin to a first rail ramp, (ii) one or more rail vendors providing rail service from the first rail ramp to a second rail ramp, (iii) one or more destination vendors providing truck service from the second rail ramp to the destination, and (iv) one or more container providers providing empty containers at a first location acceptable for at least one of the origin vendors to pick up and accepting empty containers at a second location acceptable for at least one of the destination vendors to drop off, wherein the containers are suitable for the goods, each of the origin vendors, the rail vendors, the destination vendors and the container providers is available to provide service or container during the desired time and has a quoted price for such service or container; (c) identify one or more itineraries each comprising a container provider, an origin vendor, a rail vendor and a destination vendor that collectively are able to transport the goods from the origin to the destination; and (d) calculate a total quoted price for each of the itineraries taking the quoted prices from each of the container provider, the origin vendor, the rail vendor and the destination vendor as input.

In some implementations, the code further configures the system to (e) determine an optimal total quoted price and an optimal itinerary.

In some implementations, the code further configures the system to calculate the quoted price for each of the origin vendors for each itinerary, which calculation takes as input a size of the container, a distance between the origin and the first ramp and a distance between the first location and the origin. In some implementations, the calculation further takes as input at least one of i) a distance between the origin vendor and the first location and ii) a distance between the first ramp and the origin vendor.

In some implementations, the code further configures the system to calculate the quoted price for each of the destination vendors for each itinerary, which calculation takes as input a size of the container, a distance between the second ramp and the destination, and a distance between the destination and the second location. In some implementations, the calculation further takes as input at least one of i) a distance between the destination vendor and the second ramp and ii) a distance between the second location and the destination vendor.

In some implementations, the second location is at the second ramp. In some implementations, the calculation in (d) further takes as input an incentive provided by an equipment vendor for the second location. In some implementations, the optimal total quoted price is within a range defined by the lowest five total quoted prices. In some implementations, the optimal total quoted price is within a range defined by the lowest three total quoted prices.

In some implementations, the code further configures the system to calculate a margin as the difference between the total quoted price of each itinerary and the optimal total quoted price. In some implementations, the optimal itinerary is selected as the itinerary with the highest margin.

In another implementation, the present disclosure provides a computing device comprising a processor, a memory, and program code which, when executed by the processor, configures the device to (a) receive an input from a user, which input comprises an origin location, a destination location, a description of goods to be transported from the origin location to the destination location, and a desired time for the transportation; (b) display a list of at least one quoted price for providing the transportation from the origin location to the destination location; and (c) receive a command from the user as to whether to accept the quoted price.

In some implementations, the code further configures the device to use the input to search a database comprising information regarding (i) one or more origin vendors providing truck service from the origin location to a first rail ramp, (ii) one or more rail vendors providing rail service from the first rail ramp to a second rail ramp, (iii) one or more destination vendors providing truck service from the second rail ramp to the destination location, and (iv) one or more container providers providing empty containers at a first location acceptable for at least one of the origin vendors to pick up and accepting empty containers at a second location acceptable for at least one of the destination vendors to drop off, wherein the containers are suitable for the goods, each of the origin vendors, the rail vendors, the destination vendors and the container providers is available to provide service or container during the desired time and has a quoted price for such service or container; identify one or more itineraries each comprising a container provider, an origin vendor, a rail vendor and a destination vendor that collectively are able to transport the goods from the origin location to the destination location; and calculate a total quoted price for each of the itineraries taking the quoted prices from each of the container provider, the origin vendor, the rail vendor and the destination vendor as input.

### BRIEF DESCRIPTION OF THE DRAWINGS

FIG. 1 illustrates potential routings from an origin location (Chicago) to a destination location (Bakersfield) for which containers, truck service and rail services are available for the selected time period. Dotted lines represent empty miles in which no goods are carried in the containers. Solid lines represent truck routes and double solid lines represent rail routes.

FIG. 2 is a diagram illustrating an example of an optimal cargo transportation route and rate determination environment.

FIG. 3 is a diagram illustrating an example of an itinerary management system.

FIG. 4 illustrates a flowchart of an example of a method for determining optimal routes and rates for cargo transportation.

FIG. 5 illustrates an example of a screen of a rate wizard rate request.

FIG. 6 illustrates an example of a screen of a rate wizard display.

FIG. 7 shows an example of a computer system on which techniques described in this paper can be implemented.

FIG. 8 shows an example of a routing environment in which goods and containers are sent from a goods origin to a goods destination.

FIG. 9 shows an example of a flowchart of a method for sending goods from an input door to a port along an optimized route.

FIG. 10 shows an example of a flowchart of a method for sending goods from a port to an output door along an optimized route.

FIG. 11 shows an example of a flowchart of a method for sending goods to a goods destination.

It will be recognized that some or all of the figures are schematic representations for example and, hence, that they do not necessarily depict the actual relative sizes or locations of the elements shown.

### DETAILED DESCRIPTION

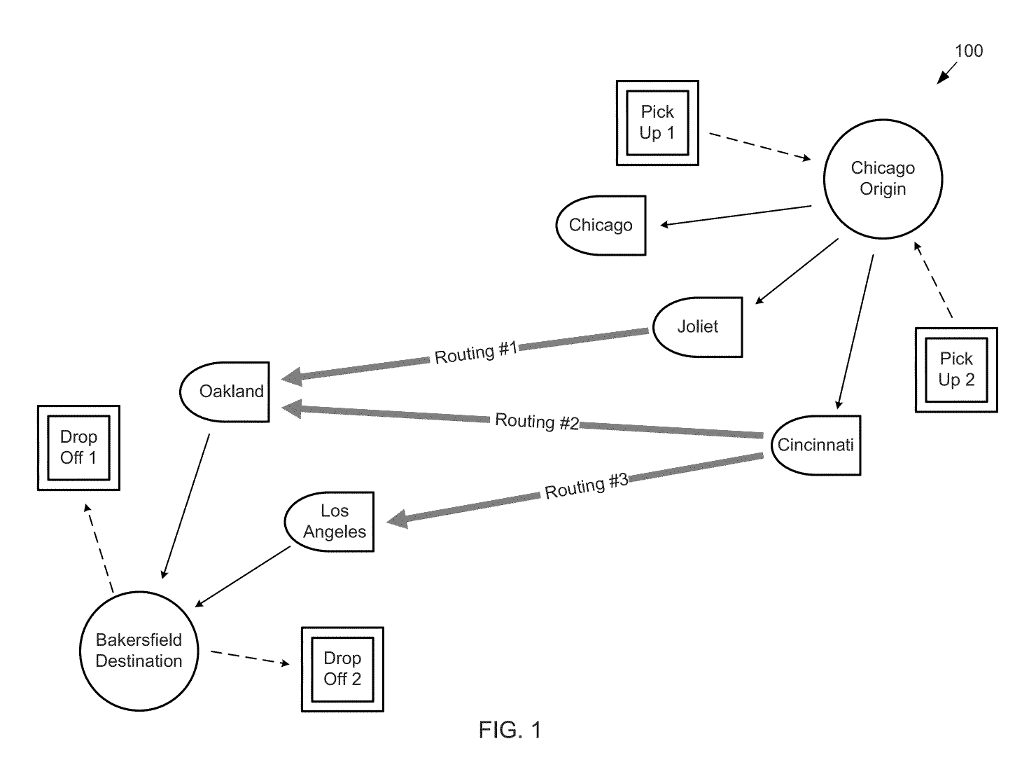

FIG. 1 illustrates potential routings from an origin location (Chicago) to a destination location (Bakersfield) for which containers, truck service and rail services are available for the selected time period. Dotted lines represent empty miles in which no goods are carried in the containers. Solid lines represent truck routes and double solid lines represent rail routes.

As illustrated in FIG. 1, Chicago, Ill. is selected by a user as the origin and Bakersfield, Calif., as the destination, at a particular date range. There are three rail ramps to which truck services are provided by a certain vendor from the origin, namely the Chicago, Joliet and Cincinnati ramps. Within the date range, rail services can be identified from Joliet to Oakland, from Cincinnati to Oakland, and from Cincinnati to Los Angeles. Oakland and Los Angeles are chosen as potential rail ramps at the destination because there are truck services available, within the date range, to move containers from these ramps to Bakersfield, the destination.

Therefore, given the availability of the origin vendors, rail vendors and destination vendors, the system can identify three potential routing itinerary. Routing #1 includes picking up, by an origin vendor, the goods from Chicago and dropping them off at Joliet, transporting the goods by rail from Joliet to Oakland, and picking up, by a destination vendor, the goods at the Oakland ramp and dropping them off at the destination. Likewise, Routing #2 is from Chicago to Cincinnati (by truck), from Cincinnati to Oakland (by rail), and from Oakland to Bakersfield (by truck), and Routing #3 is from Chicago to Cincinnati (by truck), from Cincinnati to Los Angeles (by rail) and from Los Angeles to Bakersfield (by truck). For each segment in each routing, there can be one or more vendors providing services, all of which can be considered in calculating a quote for the user.

It is noted that, even though the Chicago ramp is close to the Chicago origin and there are available truck services between them in the selected date range, no rail service is available from the Chicago ramp to either Oakland or Los Angeles in that date range. Or, even if there are available rail services, the system has not received a quote for such services. Therefore, the Chicago ramp is not selected as an origin/first ramp.

In various implementations, the system and methods shown in FIGS. 1-3 provide computer systems, methods, and non-transitory computer-readable media configured for determining optimal routes and rates for cargos (or, goods) transportation between an origin location and a destination location. A rate wizard can include an automated process for calculating and displaying available door-to-door rates for overland containerized cargo transportation by rail and truck, by monitoring the current component costs of a given cargo move from all potential service providers. Through a Cooperative Access System (CAS), the systems and methods discussed herein may provide access to long-standing partnerships with IMCs, transportation vendors, and logistics services throughout the industry, and is in an ideal position to broker transportation arrangements and equipment between IMCs, BCOs, and transportation vendors for domestic rail carriage. The rate wizard may enable operators and customers to locate and calculate the most advantageous and up-to-date rates available for a move on a specific lane, taking into account all the variable factors that contribute to those rates.

Every transportation move is characterized by a number of distinctive details. Goods are carried between a specific pair of origin and destination locations, known as a lane (also referred to as an “itinerary” in the present disclosure). For a move on any given lane, competing rail carriers may offer different routing options for the intermediate stops. The goods to be moved are identified by type, as for example Rolled Paper, Hazardous Material, or the generic Freight All Kinds (FAK). Containers are designated by a size/type class, for example, 20-foot dry van or 40-foot high cube.

In one implementation, the computer systems, methods, or non-transitory computer-readable media are configured to receive a search query that includes an origin, a destination, a description of goods to be transported from the origin to the destination, and a desired time for the transportation, and to search in a route and rate database using the search query.

Also provided, in another implementation, is a computing device comprising a processor, a memory, and program code which, when executed by the processor, configures the device to (a) receive an input from a user, which input comprises an origin location, a destination location, a description of goods to be transported from the origin location to the destination location, and a desired time for the transportation; (b) display a list of at least one quoted price for providing the transportation from the origin location to the destination location; and (c) receive a command from the user as to whether to accept the quoted price. In some implementation, the code further configures the device to use the input to search a database (or initiate a search of the database) to determine the quote prices.

In one implementation, the database includes information regarding (i) one or more origin vendors providing truck service from the origin to a first rail ramp, (ii) one or more rail vendors providing rail service from the first rail ramp to a second rail ramp, (iii) one or more destination vendors providing truck service from the second rail ramp to the destination, and (iv) one or more container providers providing empty containers at a first location acceptable for at least one of the origin vendors to pick up and accepting empty containers at a second location acceptable for at least one of the destination vendors to drop off, wherein the containers are suitable for the goods, each of the origin vendors, the rail vendors, the destination vendors and the container providers is available to provide service or container during the desired time and has a quoted price for such service or container.

By searching such a database, the systems, methods or media can then identify one or more itineraries (i.e., lanes) each comprising a container provider, an origin vendor, a rail vendor and a destination vendor that collectively are able to transport the goods from the origin to the destination.

Thus, in one implementation, the systems, methods or media are further configured to calculate a total quoted price for each of the itineraries taking the quoted prices from each of the container provider, the origin vendor, the rail vendor and the destination vendor as input.

In some implementations, the systems, methods or media are further configured to determine an optimal total quoted price and an optimal itinerary and, optionally, display the quoted price to the user. The details of each of these steps are further provided below.

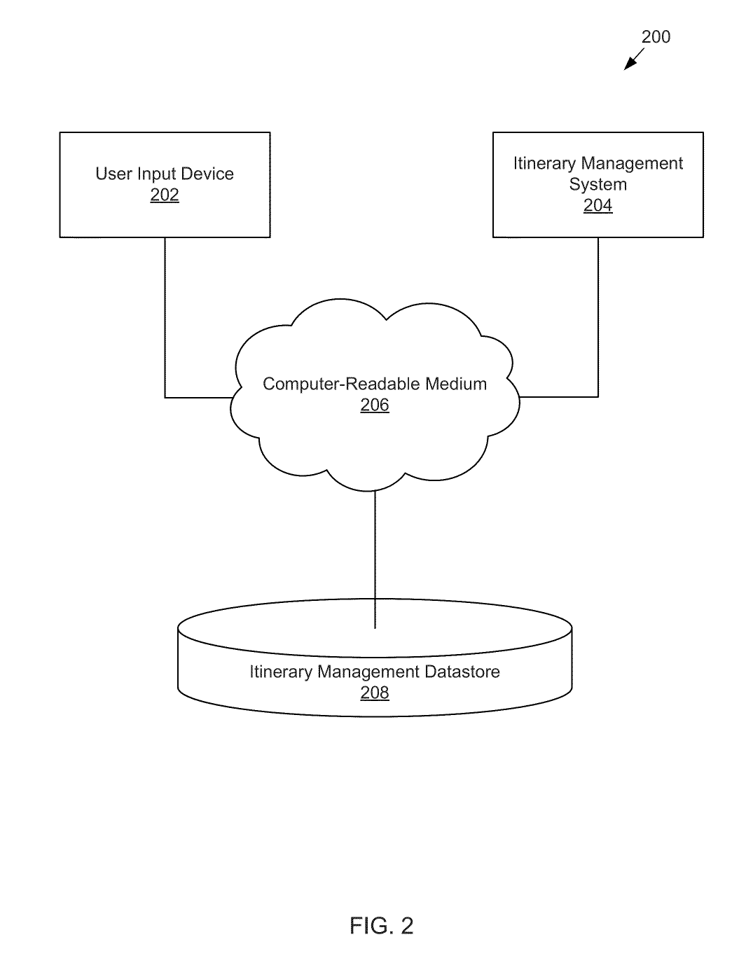

FIG. 2 is a diagram 200 illustrating example of an optimal cargo transportation route and rate determination environment. The diagram 200 includes a user input device 202, an itinerary management system 204, a computer-readable medium 206, and an itinerary management datastore 208. One or more of the elements of the diagram can include an “engine” and/or a “datastore,” as defined herein. An “engine,” as used in this paper, includes a dedicated or shared processor and, typically, firmware or software modules executed by the processor. Depending upon implementation-specific or other considerations, an engine can be centralized or its functionality distributed. An engine can include special purpose hardware, firmware, or software embodied in a computer-readable medium for execution by the processor.

A “datastore,” as used in this paper, can be implemented as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper. Datastores can include data structures. As used in this paper, a data structure is associated with a particular way of storing and organizing data in a computer so it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures for creating and manipulating instances of that structure.

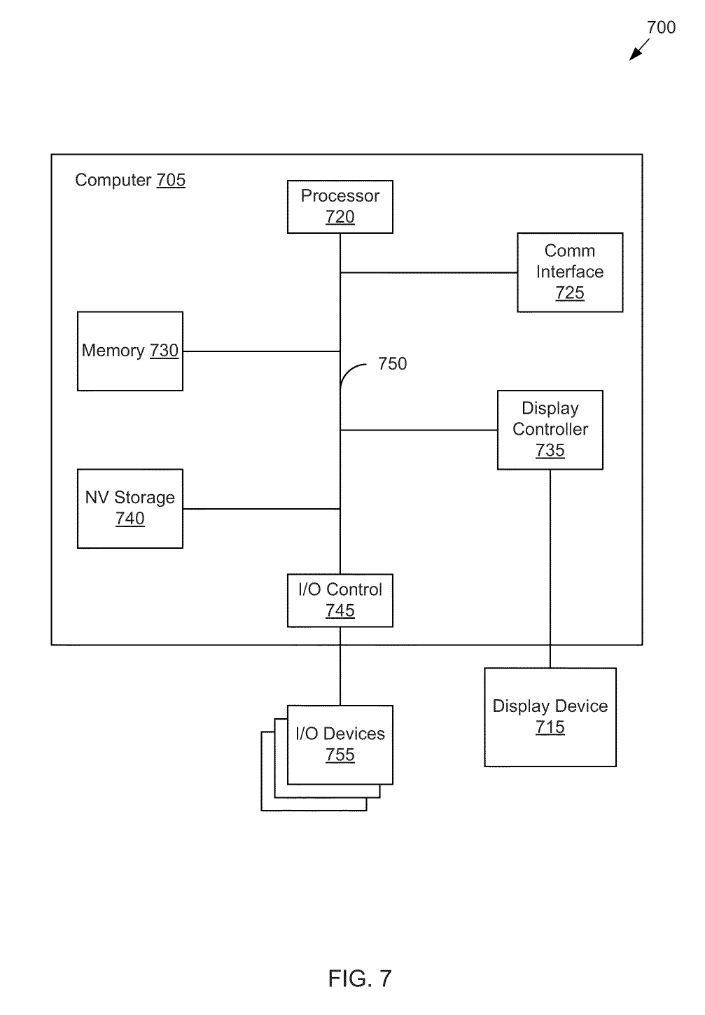

In the example of FIG. 2, the user input device 202 is coupled to the computer-readable medium 206. The user input device 202 can include any computer system, such as the computer system shown in FIG. 7. The user input device 202 can facilitate user input regarding cargo transportation route and rate determination. In some implementations, the user input device 202 receives user input that includes an origin location, a destination location, a description of goods to be transported from the origin location to the destination location, and a desired time for the transportation. The user input device 202 can also display a list of at least one quoted price for providing the transportation from the origin location to the destination location. The user input device 202 can further receive a command from the user as to whether to accept the quoted price is received. The user input device 202 can provide relevant data to and receive relevant data from the computer-readable medium 206.

In the example of FIG. 2, the itinerary management system 204 is coupled to the computer-readable medium 206. The itinerary management system 204 can include any computer system, such as the computer system shown in FIG. 7. The itinerary management system 204 can determine transportation vendors and tariffs, determine equipment vendors, empty miles, and demand locations, identify conditional charges and markups, and determine rates. In an implementation, the itinerary management system 204 can receive a search query comprising an origin, a destination, a description of goods to be transported from the origin to the destination, and a desired time for the transportation. The itinerary management system 204 can also use the search query to search a database comprising information regarding (i) one or more origin vendors providing truck service from the origin to a first rail ramp, (ii) one or more rail vendors providing rail service from the first rail ramp to a second rail ramp, (iii) one or more destination vendors providing truck service from the second rail ramp to the destination, and (iv) one or more container providers providing empty containers at a first location acceptable for at least one of the origin vendors to pick up and accepting empty containers at a second location acceptable for at least one of the destination vendors to drop off. The containers may be suitable for the goods. Each of the origin vendors, the rail vendors, the destination vendors and the container providers can be available to provide service or container during the desired time and has a quoted price for such service or container.

In an implementation, the itinerary management system 204 can identify one or more itineraries each comprising a container provider, an origin vendor, a rail vendor and a destination vendor that collectively are able to transport the goods from the origin to the destination are identified. The itinerary management system 204 can also calculate and/or provide a total quoted price is calculated for each of the itineraries taking the quoted prices from each of the container provider, the origin vendor, the rail vendor and the destination vendor as input. The itinerary management system 204 can provide data to and receive data from the computer-readable medium 206.

In the example of FIG. 2, the computer-readable medium 206 is coupled to the user input device 202, the itinerary management system 204, and the itinerary management datastore 208. In a specific implementation, the computer-readable medium 206 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 206 broadly includes, as understood from relevant context, anything from a minimalist coupling of the components illustrated in the example of FIG. 1, to every component of the Internet and networks coupled to the Internet. In some implementations, the computer-readable medium 206 is administered by a service provider, such as an Internet Service Provider (ISP).

In various implementations, the computer-readable medium 206 may include technologies such as Ethernet, 802.11, worldwide interoperability for microwave access (WiMAX), 3G, 4G, CDMA, GSM, LTE, digital subscriber line (DSL), etc. The computer-readable medium 206 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over computer-readable medium 206 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the computer-readable medium 206 includes a wired network using wires for at least some communications. In some implementations, the computer-readable medium 206 comprises a wireless network. A “wireless network,” as used in this paper may include any computer network communicating at least in part without the use of electrical wires. In various implementations, the computer-readable medium 206 includes technologies such as Ethernet, 802.11, worldwide interoperability for microwave access (WiMAX), 3G, 4G, CDMA, GSM, LTE, digital subscriber line (DSL), etc. The computer-readable medium 206 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 206 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the computer-readable medium 206 is compatible with the 802.11 protocols specified by the Institute of Electrical and Electronics Engineers (IEEE). In a specific implementation, the wireless network of the computer-readable medium 206 is compatible with the 802.3 protocols specified by the IEEE. In some implementations, IEEE 802.3 compatible protocols of the computer-readable medium 206 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the computer-readable medium 206.

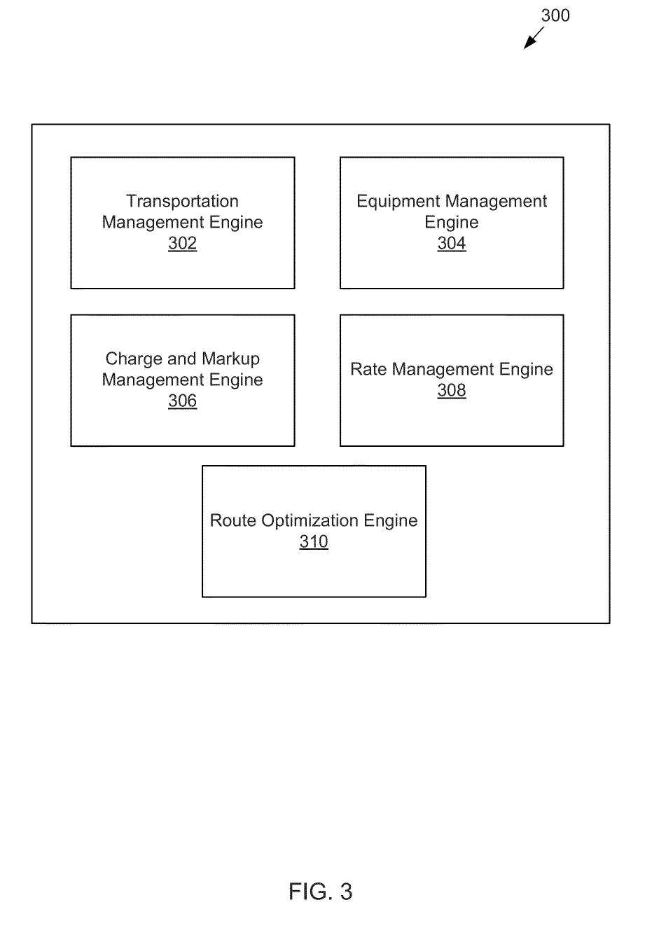

FIG. 3 is a diagram 300 illustrating an example of an itinerary management system. The itinerary management system includes a transportation management engine 302, an equipment management engine 304, a charge and markup management engine 306, a rate management engine 308, and a route optimization engine 310. One or more of the transportation management engine 302, the equipment management engine 304, the charge and markup management engine 306, the rate management engine 308, and the route optimization engine 310 can include an “engine,” as described herein. One or more of the transportation management engine 302, the equipment management engine 304, the charge and markup management engine 306, the rate management engine 308, and the route optimization engine 310 can be coupled to one another and/or to components not shown in the diagram 300.

The transportation management engine 302 can manage changes provided by vendors. In an implementation, the transportation management engine 302 manages route(s) of transportation of goods that involve various transportation vendors and equipment vendors. What is managed can include an “origin vendor” that provides truck service between the origin, wherein the goods for shipping are located, and a “first rail ramp,” which is one of the nearby rail ramps able for shipping the goods, via rail way, to one that is close to the destination (a “second rail ramp”). Likewise, the transportation management engine 302 can manage a “destination vendor” provides truck service between the second rail ramp and the destination. In this context, a “rail vendor” is one that provides rail service between the first and second rail ramps.

In an implementation, it is noted each transportation vendor establishes its own fees and charges for the services it provides. For a rail vendor, the cost of a move depends on the rail vendor's basic line haul rate and the distance covered. The costs of trucking services, on the other hand, are more complex, and are represented primarily by tariffs. A tariff is a charge for carrying equipment of a specific type on a specific lane. A tariff can be comprised of a number of individual charges including, for instance, “Empty Miles,” “Loaded Miles,” “Chassis Dray,” or “Scale Charge.” Some of these may have an attached fuel surcharge (FSC), based on a percentage of the item's cost; this percentage can vary with current prevailing market costs.

In many instances, the tariffs are valid within a range of dates, and can change frequently. Vendors typically offer a schedule of such charges for the lanes and equipment types they handle. Accordingly, the transportation management engine 302 can be kept updated with any changes provided by the vendors.

The equipment management engine 304 can manage equipment vendors, empty miles, and demand locations. Empty miles can include the miles engendered when the origin vendor picks up empty containers from the equipment vendor, or where the containers are located, and moves the empty containers to the origin to load goods. Empty miles can also be engendered when the destination vendor drops off the containers after offloading the goods at the destination (e.g., Bakersfield). Even though during these times the vendors are not moving goods, charges can still apply, but likely at a lower per-mile charge. Therefore, when determining the overall cost for an itinerary, these charges can be included.

Thus, in one implementation, the equipment management engine 304 (or in likewise manner, the methods and media) are further configured to calculate the quoted price for each of the origin vendors for each itinerary, which calculation takes as input a size of the container, a distance between the origin and the first ramp and a distance between the first location and the origin. In one implementation, the calculation further takes as input at least one of i) a distance between the origin vendor and the first location and ii) a distance between the first ramp and the origin vendor.

Once a container has been emptied, the container can be is transported to a location to load new goods. Repositioning an empty container, however, represents an added expense, so that when feasible, an equipment vendor prefers to drop off an empty container at a “demand location,” where other shippers are waiting for empty containers to use. To encourage such bookings, an equipment vendor can offer an incentive payment. In some implementations, the system of the present disclosure takes the inventive payment into consideration when determining optimal itineraries. In some implementations, the equipment management engine 304 passes a portion of the incentive on to a potential customer, and therefore the final rate for the itinerary is adjusted to take into account of this portion of the incentive.

For instance, the equipment management engine 304 may assist management of the items shown in FIG. 1. In FIG. 1, one or more equipment vendors may be able to provide empty containers at a location for origin vendors to pick up (e.g., Pick Up 1 and Pick Up 2). Meanwhile, these equipment vendors can accept that the containers, when emptied, can be dropped at a location close to the destination (e.g., Drop Off 1 and Drop Off 2). Such locations can further affect the routing and rates for transporting goods from the origin to the destination. For instance, this will add empty miles (e.g., from Pick Up 1 or 2 to Chicago, and from Bakersfield to Drop Off 1 or 2) to the itinerary.

Further, one or more of the drop off locations can be a demand location identified by the equipment vendor or recommended by the system. In such a case, the equipment vendor will be willing to provide an incentive if that drop off location is chosen. For instance, if there is a strong demand from potential customers to pick up empty containers at Drop Off 2, then an itinerary that ends at Drop Off 2 will be offered a portion of the incentive, which reduces the overall rate quoted to the user.

The charge and markup management engine 306 can manage conditional charges and markups. In one implementation, various “conditional charges” are also considered in calculating the overall costs and quotes for an itinerary. Conditional charges can be any of the variety of billable costs involved in rail and truck transportation such as, without limitation, chassis rental, overweight fees, scale charges, storage, and the like.

“Conditional credits,” in another implementation, can also be considered, which are items of the same kind credited to another party (e.g., customer and vendor). Each of these is represented by a record in the database. When a conditional charge or credit is defined for a specific combination of rail vendor, equipment supplier and owner, location, and charge type, it is applied to all the rates applicable to these values.

When the rate optimizer locates tariffs and creates a rate for a container move, each rate includes a fixed “markup” amount to be applied to the transaction. There is a standard charge for each service type, which can be adjusted as needed for bookings on specific lanes. In one implementation, a markup amount applies to all equipment size/types in the specified service; and in a related implementation, to all transactions of a given service type. In some implementations, the system creates a markup for a specific lane, e.g., from an origin ramp hub to a destination ramp hub.

Further considerations in the logistics of an intermodal cargo move relate to the presence of multiple routes between any two locations. Truck service vendors can offer different routing options, each with its own schedule of tariffs. A cargo move by rail, furthermore, can comprises multiple legs through various junctions, sometimes over track and with locomotives owned by different operators. In an implementation, the charge and markup management engine 306 can consider one or more of these variables during a search for optimal itineraries and rates.

The rate management engine 308 can manage determination of rates. Taking the above factors, or a subset of them, into consideration, the charge and markup management engine 306 can determine a rate to be charged to a customer. Such a rate can be optimal as a low rate for the customer compared to alternative itineraries and vendors, and can generate a profit for an entity that provides this system as a service. The profit, also referred to as a “margin,” is the calculated difference between the rate the entity presents to a customer and the actual cost, which is the sum of the charges collected by each vendor, minus incentives offered by the vendors. In some implementations, the final rate is based on the lowest customer cost and the highest margin, which is the “optimal” rate (optimal total quoted price) presented to the customer.

In one implementation, the optimal total quoted price is the lowest identified by the presently disclosed methods. In another implementation, the optimal total quoted price is within a range defined by the lowest five total quoted prices. In another implementation, the optimal total quoted price is within a range defined by the lowest three total quoted prices. In some implementations, a margin is calculated as the difference between the total quoted price of each itinerary and the optimal total quoted price.

In some implementations, then, the optimal itinerary is selected as the itinerary with the highest margin. The route optimization engine 310 can optimize a route between two doors. In some implementations, the route optimization engine 310 coordinates the transportation management engine 302, the equipment management engine 304, the charge and markup management engine 306, and/or the rate management engine 308 to select an optimized route between doors. An “optimized route” between doors, as discussed herein, can include a route that allows goods to be transported between the doors with maximum efficiency. In an implementation, optimizing a route between two doors may include minimizing a transportation time for goods directed between those two nodes. Minimizing transport time may entail choosing a transportation mode that is faster than alternatives. For example, route optimization engine 310 can determine that it is faster to send goods via railway and/or truck than via ship. In various implementations, optimizing a route between two nodes may include minimizing transportation cost (e.g., trucking rates rail rates, and/or ship rates) for goods directed between those two nodes. As another example, route optimization engine 310 can choose a cheaper transportation mode (e.g., via ship). In some implementations, optimizing a route between two nodes includes minimizing emissions (e.g., carbon dioxide, nitrogen, carbon monoxide, etc. emissions) involved in transporting goods between the two nodes. As yet another example, route optimization engine 310 can determine that transporting goods via rail involves less emissions than the transportation of similar goods via rail.

In some implementations, optimizing a route between two nodes may involve analysis of some combination of time, cost, and emissions. As an example of optimizing the route between two nodes, the following formula may be used: Optimized Route=f(time, cost, emissions). The function “f” may include any function that can be performed on the variables time, cost, and emissions. In an implementations, the optimized route is based on sliding scale, where more of two variables can compensate for less of one. As an example route optimization engine 310 can determine that there exists a route between two nodes a route that is faster and cheaper but involves greater emissions (e.g., via ship). The two variables, time and cost, may be used to compensate for the third variable, emissions, in the formula. In some implementations, optimizing a route between two nodes involves aggregating times, costs, and/or emissions from different transportation modes. For example, optimizing a route can involve aggregating times, costs, and emissions from shipping, railways, and trucking transportation modes. Optimizing a route between two doors can further involve determining capacity on containers traveling between those two nodes.

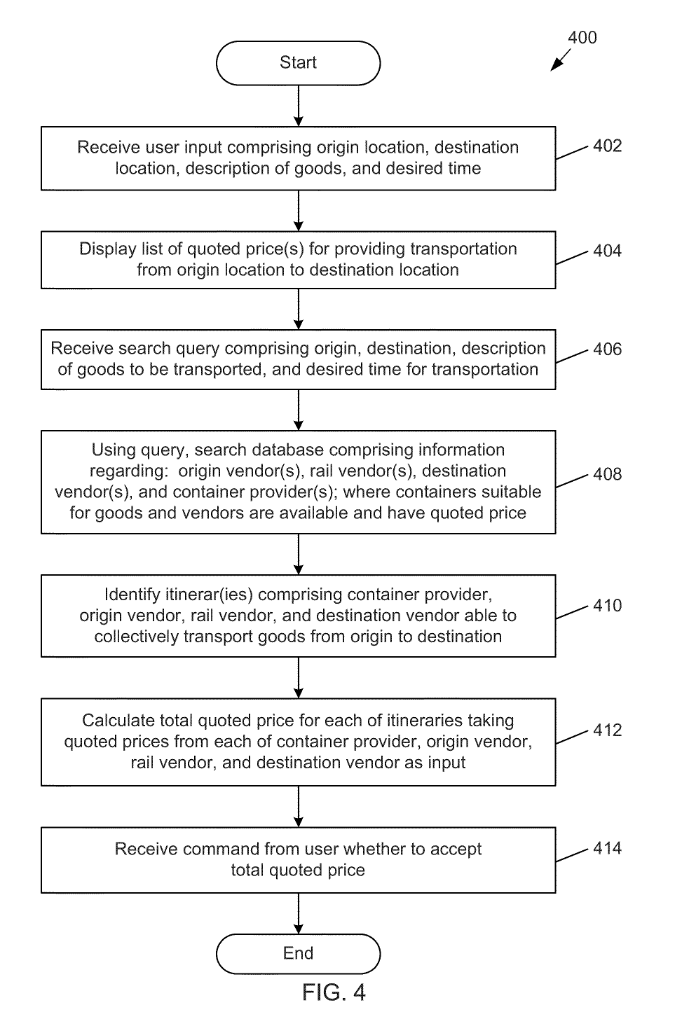

FIG. 4 illustrates a flowchart 400 of an example of a method for determining optimal routes and rates for cargo transportation. The flowchart 400 is discussed in conjunction with the specific structures and/or machines shown in FIGS. 1-3. A number of combinations of the specific structures and/or machines shown in FIGS. 1-3 may perform the steps of the method of the flowchart 400.

At block 402, an input from a user is received. The input can include an origin location, a destination location, a description of goods to be transported from the origin location to the destination location, and a desired time for the transportation. At block 404, a list of at least one quoted price for providing the transportation from the origin location to the destination location is displayed.

At block 406, a search query comprising an origin, a destination, a description of goods to be transported from the origin to the destination, and a desired time for the transportation is received. At block 408, the search query is used to search a database comprising information regarding (i) one or more origin vendors providing truck service from the origin to a first rail ramp, (ii) one or more rail vendors providing rail service from the first rail ramp to a second rail ramp, (iii) one or more destination vendors providing truck service from the second rail ramp to the destination, and (iv) one or more container providers providing empty containers at a first location acceptable for at least one of the origin vendors to pick up and accepting empty containers at a second location acceptable for at least one of the destination vendors to drop off. The containers may be suitable for the goods. Each of the origin vendors, the rail vendors, the destination vendors and the container providers can be available to provide service or container during the desired time and has a quoted price for such service or container.

At block 410, one or more itineraries each comprising a container provider, an origin vendor, a rail vendor and a destination vendor that collectively are able to transport the goods from the origin to the destination are identified. At block 412, a total quoted price is calculated for each of the itineraries taking the quoted prices from each of the container provider, the origin vendor, the rail vendor and the destination vendor as input. At block 414, a command from the user as to whether to accept the quoted price is received.

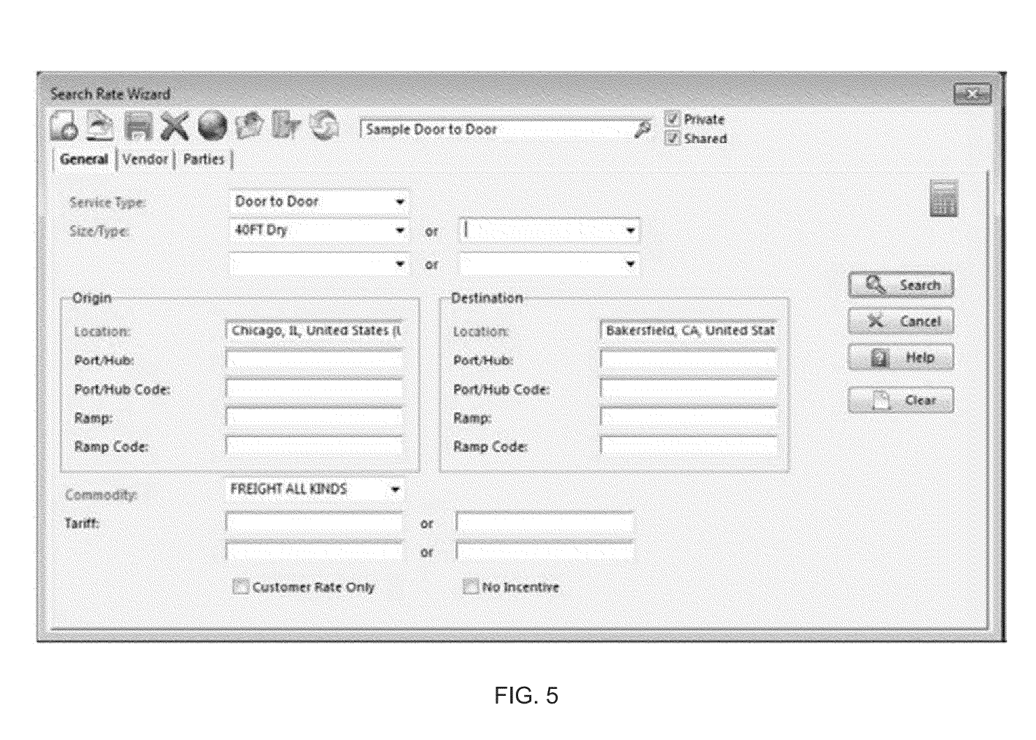

FIG. 5 illustrates an example of a screen of a rate wizard rate request. In an implementation, the operation of the system depicted in the screen includes three main components: Updating and synchronizing, matching tariffs and incentives, and retrieving and displaying rates. Regarding, updating and synchronizing, the system can collects data on tariffs and incentives from transportation vendors and stores the information in its database. The rate wizard shown in FIG. 5 can keep this data continuously updated, using triggers that respond immediately to changes.

Regarding matching tariffs and incentives, a tariff may apply to a specific combination of customer, equipment type and supplier, and in particular a specific pair of origin and destination locations, or lane. Depending on their relationship to the rail portion of the cargo move, tariffs can be for door-to-ramp, ramp-to-ramp, or ramp-to-door service. Incentives are offered for ramp-to-ramp rail service, but include specific origin and destination locations at terminals associated with the rail hubs. (Transporting equipment to and from these terminals incurs tariff charges for trucking and chassis drayage.) To calculate a rate, in addition to the other variables, the system must connect each incentive with all the door-to-ramp tariffs that match its origin, and all the ramp-to-door tariffs that match its destination.

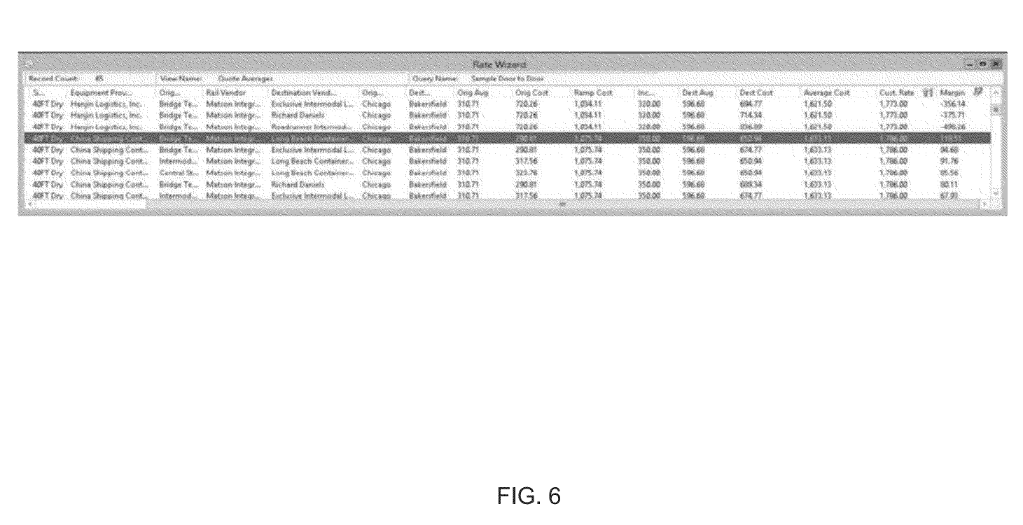

Regarding retrieving and displaying rates, the component can respond to requests from the application for a rate for a particular lane, supplier, and so on. The wizard does not store a database of fixed rates; it uses the continuously updated tariff and incentive information to calculate a rate on request. To request a rate, a SynchroNet user enters a desired location pair and other data in the Rate Wizard dialog (see FIG. 5). The application calls the rate wizard to look up the requested rates, and displays a list of the returned records (see FIG. 6). FIG. 6 illustrates an example of a screen of a rate wizard display. For each selected lane and equipment type, the system highlights a single “best” match, based on the lowest calculated customer rate and the highest margin for the system. In practice, the “best” rate can be the one presented to a customer who requests a rate quote on the company's customer web site; others are provided for internal information and analysis.

In an implementation, the systems and method described herein may implement ramp-to-ramp tariffs. More specifically, given the record ID of the newly added Incentive record, the systems and methods described herein can search for Tariff records that match it. The matching proceeds in four stages; at every stage, the procedure matches records and selects fields in the same way, with individual variations as noted below.

In every case, the procedure matches tariffs that share the same Shipment Type, container Size/Type, and Origin and Destination locations as the incentive; and that also match the following:

| Field: | Value: |
|---|---|
| Service Type | ‘Ramp to Ramp’ |
| Preferred | ‘Yes’ |
| Transport Mode | ‘Rail’ |
| Size/Type | ‘20 FT Dry’ (etc.) |
| Commodity | ‘Freight All Kinds’ |
| Origin Depot, | not null |
| Dest. Depot | |

From the matching Incentive and Tariff records, the procedure selects the following fields, writing them to the corresponding lookup table in columns named as indicated:

| lookup column: | from record: | field: |
|---|---|---|
| SVID | Incentive | ID |
| TTID | Tariff | ID |
| EQSUP | | Eqpt Supply |
| SHIPTYPE | | Shipment Type |

These matches retrieve records for tariffs that meet the following conditions: (1) Equipment supplied by SynchroNet; (2) Equipment supplied by SynchroNet (Pass 2 differs from pass 1 in that it retrieves the equipment provider from the incentive record instead of the tariff (see below)); (3) Third-party equipment, not supplied by SynchroNet; and (4) Equipment provided by the rail vendor.

As with the matching conditions, on each of the four passes, in addition to the common fields described above, the procedure selects a further specific set of fields and writes them to the lookup table as follows (as above, A denotes the matching Tariff record, C the Incentive):

| Pass | PID | OID | ORIGMATCHFIELDS | DESTMATCHFIELDS |
|---|---|---|---|---|
| 1 | C supplierid | C ownerid | A origdepotid + | A destdepotid + |
| | | | A equipmentproviderid | A equipmentproviderid |
| 2 | C supplierid | C ownerid | A origdepotid + | A destdepotid + |
| | | | C supplierid | C supplierid |
| 3 | A equipmentproviderid | A equipmentownerid | A origdepotid + | A destdepotid + |
| | | | A equipmentproviderid | A equipmentproviderid |
| 4 | C supplierid | C ownerid | A origdepotid + | A destdepotid + |
| | | | “SynchroNet” | “SynchroNet” |

It is noted the same matching conditions can be defined, and the same sets of records selected, by the procedure that processes new Tariff records.

In an implementation, the systems and methods described herein may implement multiramp tariffs. More specifically, once relevant procedures have located the ramp-to-ramp tariffs that match the new incentive, it repeats the entire process for rates with “crosstown” legs: those that include truck transportation stages between intermediate rail terminals. The tariffs for these legs are considered to be integral parts of the entire door-to-door rate's ramp-to-ramp segment, but because they apply to different carriers and transport modes and must be also be matched with rail tariffs at both of the intermediate locations, the wizard must treat them as distinct.

The process is similar to that for normal ramp-to-ramp tariffs except that instead of comparing a single tariff record at a time, the procedure's matching conditions include a set of three tariffs: rail tariffs for the leg from origin ramp 1 to destination ramp 1 (Rail 1); truck tariffs for “crosstown” transportation between the intermediate ramps (Truck); and rail tariffs for the leg from origin ramp 2 to the final destination ramp (Rail 2).

As with the ramp-to-ramp tariffs, the matching proceeds in four stages. At every stage, the procedure matches records and selects fields in the same way, with individual variations as noted below.

In every iteration of the routine, the procedure matches tariff records with one other and with the incentive record (D) by comparing the following fields:

| Field: | Rail 1 (A) | Truck (B) | Rail 2 (C) |
|---|---|---|---|
| Service | “ramp-to- | “ramp-to- | “ramp-to- |
| | ramp” | ramp” | ramp” |
| Transport Mode | “rail” | “truck” | “rail” |
| Dest. Depot | = B orig. depot | = C orig. depot | |
| sizetype, | = B, = D | = C | |
| equipmentsupply, | | | |
| shipmenttype | | | |
| commodity | = B, = | = C | |
| | “freight all kinds” | | |
| origin | = D | | |

writes data to the following columns in the lookup, selecting fields from the matching tariffs and the incentive as indicated:

| column: | from: |
|---|---|
| ORIGTTID | A ID |
| TRKTTID | B ID |
| DESTTTID | C ID |
| SVID | D ID |
| PID | D SUPPLIERID |
| OID | D OWNERID |
| EQSUP | D EQUIPMENTSUPPLY |
| SHIPTYPE | D SHIPMENTTYPE |

In addition to the common matching conditions that hold for every iteration, the four passes also match different values of the values EQUIPMENTPROVIDERID and EQUIPMENTSUPPLY. The additional matching conditions for each pass are:

| Pass | Field: | Rail 1 (A) | Truck (B) | Rail 2 (C) | Incentive (D) |
|---|---|---|---|---|---|
| 1 | Equipmentproviderid | “SynchroNet” | “SynchroNet” | “SynchroNet” | “Private” |
| | equipmentsupply | | | | |
| 2 | Equipmentproviderid | “SynchroNet” | “SynchroNet” | “SynchroNet” | “Private” |
| | equipmentsupply | | | | |
| 3 | Equipmentproviderid | not “SynchroNet”; = | | | “Private” |
| | equipmentsupply | D supplierid | | | |
| 4 | Equipmentproviderid | not “SynchroNet”; = | | | |
| | | D supplierid | | | |

When selecting and inserting fields from the matching records, in addition to the common fields described above, each of the four passes also writes to a pair of columns named ORIGMATCHFIELDS and DESTMATCHFIELDS, which are constituted as follows:

| Pass | ORIGMATCHFIELDS | DESTMATCHFIELDS |
|---|---|---|
| 1 | A origdepotid + | C destdepotid + |
| | D supplierid | D supplierid |
| 2 | A origdepotid + | C destdepotid + |
| | A equipmentproviderid | A equipmentproviderid |
| 3 | A origdepotid + | C destdepotid + |
| | A equipmentproviderid | A equipmentproviderid |
| 4 | A origdepotid + | C destdepotid + |
| | “SynchroNet” | “SynchroNet” |

The relevant procedures can repeat the process of retrieving tariffs of both types and populating the lookup tables three more times, once each for the remaining container size/type designations it recognizes: 40 FT Dry, 40 FT High Cube, and 45 FT High Cube. In each iteration, it matches simple ramp-to-ramp tariffs, then multiramp tariffs. When the eight lookup tables have been populated, the procedure goes on to add records for them to the database's Rate table.

Once it has matched the new incentive record with ramp-to-ramp and multiramp tariffs for all four recognized container size/types, the processes herein can extract data from the Incentive and Tariff records into the ramp-to-ramp rate table, where they will be available for user database queries external to the rate wizard. Here again, it proceeds by matching the incentive with tariff records and writing specific fields from the matching records to the table. In this case it performs the operation three times, each time with variations on the basic common parameters.

In an implementation, the systems and methods described herein add door-to-door, door-to-ramp, and ramp-to door tariffs. Unlike the incentives and ramp-to-ramp rates, which refer only to the ramp-to-ramp portion of a transaction, door-to-door rates include tariffs for transportation by truck, both from the original pickup location to the origin rail ramp and from the destination ramp to the final delivery point. The tariffs for these legs must match their ramp-to-ramp counterparts at both the origin and destination hub locations. Only tariffs that the systems and methods herein account managers have marked as ‘Preferred’ are used in the rate wizard's operations. If the inserted Tariff record is so marked and the commodity is ‘Freight All Kinds,’ the procedure next retrieves the values of SIZETYPE, SERVICETYPE, and TRANSPORTMODE into the variables SZT, SRV, and TMODE respectively. If SZT is null, then there is no matching record, and the procedure returns control to the trigger that called it. It next evaluates SRV. This may have one of the three values ‘Door to Ramp,’ ‘Ramp to Door,’ and ‘Ramp to Ramp,’ as a tariff may apply to any one of these three legs of a door-to-door move. The first two are handled straightforwardly; the third is more complex.

When the service type is ‘Door to Ramp’ or ‘Ramp to Door,’ the procedure performs a further match on the value of SIZETYPE (SZT). From any matching Tariff records, it copies the record ID, pickup or delivery location, and rail depot location+equipment provider into a corresponding lookup table; like those used for the incentives, these are named by service type, size/type, and commodity (e.g., DOORTORAMP20 FTDRYFAK, RAMPTODOOR45 FTHCFAK). The basic operation for door-to ramp tariffs is:
if SZT=‘20 FT Dry’ then
insert into PARASOL.DOORTORAMP20FTDRYFAK with auto name select
A.ID as TTID,
A.ORIGDEPOTID as ORIGIN,
A.DESTDEPOTID ∥ A.EQUIPMENTPROVIDERID as MATCHFIELDS from
PARASOL.STACKTRAINTARIFF as A where A.ID=TID end if
(TID is the ID of the inserted Tariff record, passed in to the procedure by the trigger that calls it.) For ramp-to-door tariffs, the origin and destination fields are reversed:
select A.ID as TTID,
A.DESTDEPOTID as DESTINATION,
A.ORIGDEPOTID ∥ A.EQUIPMENTPROVIDERID as MATCHFIELDS

For both door-to-ramp and ramp-to-door tariffs, the same operation is applied to all four equipment size/types in order.

Ramp-to-ramp tariffs can be more complex than door tariffs because (1) they may need to be matched with corresponding incentives at both origin and destination, and (2) they can include not only rail but also truck-transportation tariffs for the “crosstown” legs of multiramp moves. Thus the procedure must handle separately not only tariffs for the four recognized container size/types, but those for the two transportation modes ‘Rail’ and ‘Truck.’

Matching of ramp-to-ramp rail tariffs proceeds in two stages, retrieving:
1. standard ramp-to-ramp rail tariffs
2. multiramp tariffs

The standard ramp-to-ramp rail tariffs are matched in exactly the same way as when inserting a new incentive record (2.1.1.1): in four passes that match the tariff with the same combinations of equipment provider (SynchroNet vs. non-SynchroNet) and equipment supply (′Vendor′ vs. ‘Private’), select the same fields from the matching records, and write them to the same columns in the corresponding lookup tables (e.g., RAM PTORAM P20 FTDRYFAK). Again, it performs the operation for each of the four equipment size/types.

The procedure for multiramp rail tariffs is exactly like the one applied by RateProcessNewIncentive (2.1.1.2): it matches tariffs in sets of three, and proceeds in four passes to select specific combinations of equipment provider (SynchroNet vs. not-SynchroNet) and supply (′Private′ vs. ‘Vendor’). The set of four passes is made twice: once to match tariffs for rail leg 1 (A), and again for those for leg 2 (C).

After finding tariffs for the rail portions of multiramp moves, the wizard matches the “crosstown” trucking legs. It finds these in exactly the same way that it did when inserting a new incentive record (2.1.1.2): comparing ramp-to-ramp tariffs in sets of three, selecting fields as described in FIG. 3, and writing them to the corresponding lookup table (e.g., MULTIRAMPTORAMP20 FTDRYFAK). It follows the same pattern of four passes, isolating the same combinations of equipment provider (SynchroNet vs. non-SynchroNet) and equipment supply (′Vendor′ vs. Trivate′); and again performs the entire operation for each of the four equipment size/types.

FIG. 7 shows an example of a computer system 700 on which techniques described in this paper can be implemented. The computer system 700 can be a conventional computer system that can be used as a client computer system, such as a wireless client or a workstation, or a server computer system. The computer system 700 includes a computer 705, I/O devices 755, and a display device 715. The computer 705 includes a processor 720, a communications interface 725, memory 730, display controller 735, non-volatile storage 740, and I/O controller 745. The computer 705 may be coupled to or include the I/O devices 755 and display device 715.

The computer 705 interfaces to external systems through the communications interface 725, which may include a modem or network interface. It will be appreciated that the communications interface 725 can be considered to be part of the computer system 700 or a part of the computer 705. The communications interface 725 can be an analog modem, ISDN modem, cable modem, token ring interface, satellite transmission interface (e.g. “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 755 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computer system 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 730 for execution by the processor 720. A Web TV system, which is known in the art, is also considered to be a computer system, but it may lack some of the features shown in FIG. 7, such as certain input or output devices. A typical computer system will usually include at least a processor, memory, and a bus coupling the memory to the processor.

In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

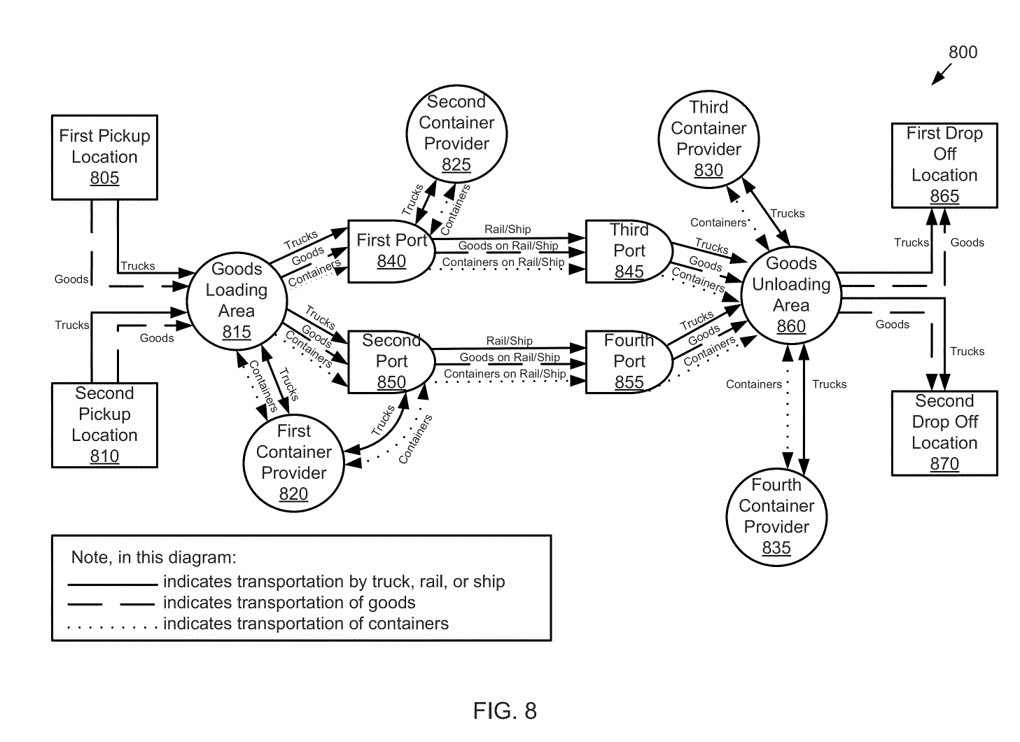

FIG. 8 shows an example of a goods routing environment 800 in which goods can be loaded at a goods loading area 815 into containers that can be sent to a goods unloading area 860 along optimal routes between the goods loading area 815 and the goods unloading area 860. In the example of FIG. 8, the goods routing environment 800 includes a first pickup location 805, a second pickup location 810, the goods loading area 815, a first container provider 820, a second container provider 825, a third container provider 830, a fourth container provider 835, a first port 840, a second port 850, a third port 845, a fourth port 855, the goods unloading area 860, a first drop off location 865, and a second drop off location 870.

In the example of FIG. 8, the first pickup location 805 corresponds to a first physical location where goods can be picked up. “Goods,” as used herein, can include any item that can be transported. Goods can be tangible. Goods may or may not correspond to the definition of goods under the Uniform Commercial Code (UCC). In a specific implementation, the first pickup location 805 is accessible by trucking services. For example, the first pickup location 805 can include a physical location where goods can be loaded onto trucks by a trucking service. The first pickup location 805 can correspond to a physical location of a person or entity seeking to send goods to the first drop off location 865 or the second drop off location 870. It may be noted the trucks that take goods from the first pickup location to the goods loading area 815 may or may not include container trucks and could be replaced with any applicable means of transportation. Moreover, the goods loading area 815 could include a goods manufacturing system, which could obviate the need to transport goods to the goods loading area 815 via truck or other means of transportation.

In the example of FIG. 8, the second pickup location 810 corresponds to a second physical location where goods can be picked up. The second pickup location 810 can be accessible by trucking services. The second pickup location 810 can correspond to a physical location of a person or entity seeking to send goods to the first drop off location 865 or the second drop off location 870. The entity associated with the second pickup location 810 may or may not correspond to the entity associated with the first pickup location 805. The second pickup location 810 is intended to illustrate that the system illustrated in the example of FIG. 8 has more than one party with goods for transport.

Different parties may or may not have their goods loaded onto shared containers, which are sometimes referred to as less than truckload (LTL) loads. LTL carriers typically use “hub and spoke” operations where small local terminals are the spokes and larger more central terminals are the hubs (also called distribution centers). In the example of FIG. 8, to the extent LTL is utilized, the LTL carriers deliver goods from the goods loading area 815 and provide other goods to the goods loading area 815 for consolidation (or not) into full containers.

In the example of FIG. 8, the goods loading area 815 corresponds to a physical location where goods can be loaded into containers. A “container,” as used herein, can include any convenient structure for carrying goods. Containers may include shipping containers having the strength to withstand shipment, storage, and/or handling. In an implementation, the containers comprise intermodal freight containers. The containers can have standardized sizes, such as sizes compliant with International Organization for Standards (“ISO”) standards. For example, the containers can be sized to have lengths between eight and fifty-six feet, and have heights from eight feet to nine and a half feet. In an implementation, the containers can include corrugated steel. The containers may be configured to be stacked on top of each other and/or grouped together. In an implementation, the containers at the goods loading area 815 are configured to be transported over a variety of transportation modes, such as over cargo ship, rail, and truck.

The goods loading area 815 can be accessible by trucking services. In some implementations, the goods loading area 815 corresponds to a location staffed by professionals who specialize in loading goods into containers. For example, the goods loading area 815 can correspond to a physical location of an origin vendor, examples of which are discussed further herein. In an implementation, the goods loading area 815 is within trucking distance of the first pickup location 805 and the second pickup location 810, the first container provider 820, the first port 840, and the second port 850. The goods loading area 815 can receive goods provided by trucking services from the first pickup location 805 or the second pickup location 810. The goods loading area 815 can also receive containers provided by trucking services from the first container provider 820. As discussed further in this paper, goods can be loaded onto specific containers, which in turn, can be sent to the first port 840 and/or the second port 850.

In the example of FIG. 8, the first container provider 820 corresponds to a first physical location where containers are provided and/or returned. The first container provider 820 can be accessible by trucking services. The first container provider 820 can correspond to a physical location of a person or entity that provides containers used for transporting goods. In a specific implementation, the first container provider 820 corresponds to a physical location of a container provider, examples of which are further provided in this paper. The first container provider 820 can be located within trucking distance of the goods loading area 815 and the second port 850. Alternatively, the first container provider 820 (or any other container providers, e.g., 825, 830, 835) can be treated as a transitory node in certain instances, such as when a truck with a container travels directly from port to loading area (or other location) without utilizing an interim location. It may be noted the trucks and container brought to a port can have goods (not illustrated as passing between the container providers and ports in the example of FIG. 8), but a description of the goods is omitted in favor of focusing only on the goods transported from goods loading area 815 to goods unloading area 860 in the continuing example.

In the example of FIG. 8, the second container provider 825 corresponds to a second physical location where containers are provided and/or returned. The second container provider 825 can correspond to a physical location of a person or entity that provides containers used for transporting goods. In a specific implementation, the second container provider 825 corresponds to a physical location of a container provider, examples of which are further provided in this paper. The second container provider 825 can be located within trucking distance of the first port 840.

In the example of FIG. 8, the third container provider 830 corresponds to a third physical location where containers are provided and/or returned. The third container provider 830 can correspond to a physical location of a person or entity that provides containers used for transporting goods. In a specific implementation, the third container provider 830 corresponds to a physical location of a container provider, examples of which are further provided in this paper. The third container provider 830 can be located within trucking distance of the goods unloading area 860.

In the example of FIG. 8, the fourth container provider 835 corresponds to a fourth physical location where containers are provided and/or returned. The fourth container provider 835 can correspond to a physical location of a person or entity that provides containers used for transporting goods. In a specific implementation, the fourth container provider 835 corresponds to a physical location of a container provider, examples of which are further provided in this paper. The fourth container provider 835 can be located within trucking distance of the fourth port 855 and the goods unloading area 860.

In the example of FIG. 8, the first port 840 corresponds to a first physical location where containers can be loaded and/or unloaded from trucks, rail cars, and/or ships. In a specific implementation, the first port 840 includes at least portions of a port. A “port,” as discussed herein, can include a location where transportation of full containers, Less than Truckload (“LTL”) containers, and/or empty containers is arranged. A “port” can also include an area where customs fees, import taxes, export taxes, and/or other tariffs are assessed. In an implementation, a port includes at least a portion of a shipyard or a railyard. In a specific implementation, the first port 840 is accessible by trucking services. The first port 840 can also be accessible by railway services or shipping services. For example, the first port 840 can comprise a railway facility or a shipping facility that also includes trucking ramps. In a specific implementation, the first port 840 is associated with a rail vendor, such as an entity that manages transportation over a railway. As such, the first port 840 can include one or more rail ramps. In other implementations, the first port 840 is associated with a shipping vendor, such as an entity that manages a shipyard. As a result, the first port 840 can include one or more shipping ramps. The first port 840 can be located within trucking distance of the goods loading area 815 and the second container provider 825. In an implementation, the first port 840 is coupled to the third port 845 via a railway route or a shipping route. A “route,” as discussed herein, can include an established path of transportation between two locations. Examples of routes include a rail route, which couples two locations using a railway, and a shipping route, which couples two locations using ships. The first port 840 can include an origin port for transporting goods from the goods loading area 815 to the goods unloading area 860. An “origin port,” as described herein, can include a port that is located within trucking distance of a goods loading area, such as the goods loading area 815.

In the example of FIG. 8, the second port 850 corresponds to a second physical location where containers can be loaded and/or unloaded from trucks, rail cars, and/or ships. The second port 850 can include at least portions of a port, as discussed herein. The second port 850 can be accessible by trucking services, railway services, and/or shipping services. In an implementation, the second port 850 is located within trucking distance of the goods loading area 815 and the first container provider 820. The second port 850 can include trucking ramps, railway ramps, and/or shipping ramps. In an implementation, the second port 850 is coupled to the fourth port 855 via a railway route or a shipping route. The second port 850 can include an origin port for transporting goods from the goods loading area 815 to the goods unloading area 860.

In the example of FIG. 8, the third port 845 corresponds to a third physical location where containers can be loaded and/or unloaded from trucks, rail cars, and/or ships. The third port 845 can include at least portions of a port, as discussed herein. The third port 845 can be accessible by trucking services, railway services, and/or shipping services. In an implementation, the third port 845 is located within trucking distance of the goods unloading area 860. The third port 845 can include trucking ramps, railway ramps, and/or shipping ramps. In an implementation, the third port 845 is coupled to the first port 840 via a railway route or a shipping route. The third port 845 can include a destination port for transporting goods from the goods loading area 815 to the goods unloading area 860. A “destination port,” as described herein, can include a port that is located within trucking distance of a goods unloading area, such as the goods unloading area 860.

In the example of FIG. 8, the fourth port 855 corresponds to a fourth physical location where containers can be loaded and/or unloaded from trucks, rail cars, and/or ships. The fourth port 855 can include at least portions of a port, as discussed herein. The fourth port 855 can be accessible by trucking services, railway services, and/or shipping services. In an implementation, the fourth port 855 is located within trucking distance of the goods unloading area 860. The fourth port 855 can include trucking ramps, railway ramps, and/or shipping ramps. In an implementation, the fourth port 855 is coupled to the second port 850 via a railway route or a shipping route. The fourth port 855 can include a destination port for transporting goods from the goods loading area 815 to the goods unloading area 860.

In the example of FIG. 8, the goods unloading area 860 corresponds to an area where goods can be unloaded from containers. The goods unloading area 860 can be accessible by trucking services. In some implementations, the goods unloading area 860 corresponds to a location staffed by professionals who specialize in loading goods onto containers. For example, the goods unloading area 860 can correspond to a physical location of a destination vendor, examples of which are discussed further herein. In an implementation, the goods unloading area 860 is within trucking distance of the first drop off location 865 and the second drop off location 870, the third container provider 830, the fourth container provider 835, the third port 845, and the fourth port 855. The goods unloading area 860 can receive goods provided by trucking services from the third port 845 and/or the fourth port 855. The goods unloading area 860 can also receive containers provided by trucking services from the third container provider 830 and the fourth container provider 835.

In the example of FIG. 8, the first drop off location 865 corresponds to an a first physical location where goods can be dropped off. For example, the first drop off location 865 can include a physical location where goods can be unloaded from trucks by a trucking service. The first drop off location 865 can correspond to a physical location of a person or entity seeking to receive goods from the first pickup location 805 or the second pickup location 810.

The second drop off location 870 can correspond to a second physical location where goods can be dropped off. The second drop off location 870 can be accessible by trucking services. The second drop off location 870 can correspond to a physical location of a person or entity seeking to receive goods from the first pickup location 805 or the second pickup location 810. The entity associated with the second drop off location 870 may or may not correspond to the entity associated with the first drop off location 865.

As with other examples depicted in the figures and described in this paper, it is noted the elements of the goods routing environment 800 are depicted by way of example only, and that other examples can include different configurations of elements without departing from the scope and substance of the inventive concepts discussed herein. For example, although FIG. 8 shows two pickup locations (e.g., the first pickup location 805 and the second pickup location 810), various implementations include one pickup location or more than two pickup locations. As another example, although FIG. 8 shows two drop off locations (e.g., the first drop off location 865 and the second drop off location 870), various implementations include one drop off location or more than two drop off locations. As yet another example, though FIG. 8 shows the various locations therein distinct from one another, in some implementations, two or more of the locations shown in FIG. 8 may be co-located or otherwise consolidated. As yet another example, though FIG. 8 shows four ports, various implementations can include more or less ports. As yet another example, though the ports in FIG. 8 are directly connected to one another (e.g., the first port 840 is directly connected to the third port 845 and the second port 850 is directly connected to the fourth port 855), it is noted in specific implementations, various ports may be indirectly coupled to one another using, intermediate ports or other intermediate locations.

In some implementations, the goods routing environment 800 shown in FIG. 8 operates to facilitate transportation of goods from pickup locations to drop off locations over routes between the pickup locations and the drop off locations. In some implementations, the route includes an optimized route between pickup locations and drop off locations.

. An “optimized route” between nodes, as discussed herein, can include a route that allows goods to be transported between the nodes with maximum efficiency. In an implementation, optimizing a route between two nodes may include minimizing a transportation time for goods directed between those two nodes. Minimizing transport time may entail choosing a transportation mode that is faster than alternatives. For example, it may be determined that it is faster to send goods via railway and/or truck than via ship. In various implementations, optimizing a route between two locations may include minimizing transportation cost (e.g., trucking rates rail rates, and/or ship rates) for goods directed between those two nodes. As another example, a cheaper transportation mode (e.g., via ship) may be chosen. In some implementations, optimizing a route between two nodes includes minimizing emissions (e.g., carbon dioxide, nitrogen, carbon monoxide, etc. emissions) involved in transporting goods between the two nodes. As yet another example, it may be determined that transporting goods via rail involves less emissions than the transportation of similar goods via rail. In some implementations, optimizing a route between two nodes may involve analysis of some combination of time, cost, and emissions. As an example of optimizing the route between two nodes, the following formula may be used: Optimized Route=f(time, cost, emissions). The function “f” may include any function that can be performed on the variables time, cost, and emissions. In an implementations, the optimized route is based on sliding scale, where more of two variables can compensate for less of one. As an example, it may be determined that there exists a route between two nodes a route that is faster and cheaper but involves greater emissions (e.g., via ship). The two variables, time and cost, may be used to compensate for the third variable, emissions, in the formula. In some implementations, optimizing a route between two nodes involves aggregating times, costs, and/or emissions from different transportation modes. For example, optimizing a route can involve aggregating times, costs, and emissions from shipping, railways, and trucking transportation modes. Optimizing a route between two nodes can further involve determining capacity on containers traveling between those two nodes.

At the first pickup location 805, goods that are to be transported can be itemized and categorized for transportation. In some implementations, the goods can be gathered into groups that are to be transported together. For example, goods that are later to be put into common containers can be grouped together. As another example, soft goods can be gathered into a first group, while hard goods can be gathered into a second group. As yet another example, goods having common security concerns (e.g., explosives, controlled substances, etc.) can be grouped together. In an implementation, goods that are to share a common tariff or rate can be gathered into common groups.

Goods can be placed onto trucks at the first pickup location 805. The trucks can transport the goods to the goods loading area 815. The trucks may be associated with an origin vendor. For instance, the trucks may be owned, leased, borrowed, etc. by an origin vendor. At least some of the trucks can include empty trucks before they are loaded with goods. At least some of the trucks can include LTL trucks that can be loaded with more goods.

In an implementation, the number of trucks used to transport the goods between the first pickup location and the goods loading area 815 can be optimized based on the time(s) required to transport the goods between the first pickup location 805 and the goods loading area 815, the cost of transporting the goods between the first pickup location 805 and the goods loading area 815, the emissions incurred when transporting the goods between the first pickup location 805 and the goods loading area 815, or some combination of time(s), cost(s) and emissions. For example, in an implementation, a greater number of trucks can be chosen to transport the goods to the goods loading area 815 so that the transportation time between the first pickup location 805 and the goods loading area 815 is minimized. As another example, a lesser number of trucks can be chosen to transport the goods to the goods loading area 815 so that the cost of transporting goods between the first pickup location 805 and the goods loading area 815 is minimized. A lesser number of trucks may also be chosen to minimize emissions associated with transporting goods between the first pickup location 805 and the goods loading area 815. A larger number of hybrid trucks or trucks using cleaner or alternative fuels can also be chosen to reduce emissions.

In an implementation, the capacity of trucks from the first pickup location 805 to the goods loading area 815 can be optimized based on the time(s) required to transport the goods between the first pickup location 805 and the goods loading area 815, the cost of transporting the goods between the first pickup location 805 and the goods loading area 815, the emissions incurred when transporting the goods between the first pickup location 805 and the goods loading area 815, or some combination of time(s), cost(s), and emissions. As an example, more empty trucks can be chosen to transport the goods to the goods loading area 815 so that the transportation time between the first pickup location 805 and the goods loading area 815 is minimized. As another example, more LTL trucks can be chosen to transport the goods to the goods loading area 815 so that the cost of transporting goods between the first pickup location 805 and the goods loading area 815 is minimized. More LTL can also be chosen to minimize emissions associated with transporting goods between the first pickup location 805 and the goods loading area 815.

In an implementation, the loading time of trucks at the first pickup location 805 is optimized based on the time(s) required to transport the goods between the first pickup location 805 and the goods loading area 815, the cost of transporting the goods between the first pickup location 805 and the goods loading area 815, the emissions incurred when transporting the goods between the first pickup location 805 and the goods loading area 815, or some combination of time(s), cost(s), and emissions. More specifically, additional staffing can be used at the first pickup location 805 to load trucks faster, while less staffing can be used at the first pickup location 805 to reduce costs.

At the second pickup location 810, goods that are to be transported can be itemized and categorized for transportation. As with the goods loaded into trucks at the first pickup location 805, the goods at the second pickup location 810 can be gathered into groups that are to be transported together. Once goods are itemized and/or categorized at the second pickup location 810, these goods can be loaded onto trucks at the second pickup location 810. The number, capacity, and/or loading time of trucks going from the second pickup location 810 to the goods loading area 815 can be optimized in a manner similar to the optimization of the number, capacity, and/or loading time of trucks going from the first pickup location 805 to the goods loading area 815.

The goods from the first pickup location 805 and/or the second pickup location 810 can be loaded onto trucks and provided to the goods loading area 815.

The goods can be loaded onto containers at the goods loading area 815. A specific number of containers for the goods can be provided from the first container provider 820. The choice of containers can be based on optimizing the time(s) required to transport the goods between the first pickup location 805 and the goods loading area 815, the cost of transporting the goods between the first pickup location 805 and the goods loading area 815, the emissions incurred when transporting the goods between the first pickup location 805 and the goods loading area 815, or some combination of time(s), cost(s) and emissions. In a specific implementation, the specific containers for the goods may be optimized based on the time(s) required to transport the goods between the first pickup location 805 and the goods loading area 815, the cost of transporting the goods between the first pickup location 805 and the goods loading area 815, the emissions incurred when transporting the goods between the first pickup location 805 and the goods loading area 815, or some combination of time(s), cost(s) and emissions. As an example, a larger number of empty containers can be used to contain the goods so that the transportation time from the goods loading area 815 is minimized. As another example, a larger number of LTL containers can be used to contain the goods so that the cost of transporting goods from the goods loading area 815 is minimized. As yet another example, a larger number of LTL containers can be used to minimize emissions associated with transporting goods from the goods loading area 815.

In a specific implementation, the number, capacity, and/or loading time of trucks going from the goods loading area 815 can be optimized in a manner similar to the optimization of the number, capacity, and/or loading time of trucks going from the first pickup location 805 and/or second pickup location 810 to the goods loading area 815. For example, a larger number of trucks can be used to minimize transportation times, and smaller numbers of trucks can be used to reduce cost and/or emissions.

One or more origin ports may be chosen for the containers loaded at the goods loading area 815. For example, the first port 840 and/or the second port 850 may be chosen for the containers loaded at the goods loading area 815. As discussed further in this paper, there may be multiple ports between the goods loading area 815 and the goods unloading area 860. The choice of one or more origin ports can depend on a need to optimize time(s), cost(s), emissions, or some combination thereof, of transporting goods between the goods loading area 815 and the goods unloading area 860. As an example, ports that are closer to the goods loading area 815 can be chosen to minimize transportation time. As another example, ports that are less busy can also be chosen to minimize transportation times by reducing delays associated with congestion. As yet another example, ports with lesser rates and/or tariffs can be chosen to reduce transportation costs. As yet another example, ports that implement environmentally friendly protocols (e.g., use cleaner fuels) can be chosen to reduce emissions. Other ports that do not reside along an optimized route or that do not use optimized rates need not be chosen for transporting the loaded containers from the goods loading area 815. Trucks having containers loaded with goods can be provided to the chosen port(s).

At the chosen origin port(s), the containers can be loaded onto rail services and/or shipping services. For example, containers transported from the goods loading area 815 and received at the first port 840 and/or second port 850 can be placed on railway cars using rail ramps at the first port 840 and/or second port 850. As another example, containers transported from the goods loading area 815 and received at the first port 840 and/or second port 850 can be placed on ships using shipping ramps at the first port 840 and/or second port 850. The choice of rail services and/or shipping services can depend on a need to optimize time(s), cost(s), emissions, or some combination. As an example, rail services and/or shipping services that directly connect the origin port to a destination port can be chosen to reduce transportation times. As another example, lower cost rail services and/or shipping services can be used to reduce costs. As yet another example, indirect rail services and/or shipping services can be chosen to reduce costs. As yet another example, rail services and/or shipping services using clean fuels can be chosen to reduce emissions.

In an implementation, the goods received at the chosen origin port(s) can be reloaded into other containers that are available or will be available at the origin port(s). The choice of these other containers can depend on a need to optimize time(s), cost(s), emissions, or some combination thereof, of transporting goods between the goods loading area 815 and the goods unloading area 860. For example, a limited number of other containers can be chosen if transportation times are to be minimized. More specifically, in implementations seeking to minimize transportation times, the containers from the goods loading area 815 are forwarded from the chosen origin port(s) to destination port(s) coupled to the chosen origin part(s). As another example, a larger number of other containers can be chosen if costs or emissions are to be minimized. Other containers used to minimize costs can include empty containers or LTL containers that are accessible at the chosen origin port(s). In an implementation, the other containers are brought to the chosen origin port(s) from a container provider near the chosen origin port(s). Other containers could be brought to the first port 840 from the second container provider 825, or other containers could be brought to the second port 850 from the first container provider 820.

In various implementations, unused containers can be returned from the chosen origin port(s) to container provider(s) associated with the chosen origin port(s). For example, unused containers can be returned from the first port 840 to the second container provider 825 via truck services. Unused containers can be returned from the second port 850 to the first container provider 820 via truck services.

Containers loaded with goods can be transported from the chosen origin port(s) to destination port(s) associated with the chosen origin port(s). For example, loaded containers can be transported from the first port 840 to the third port 845, and from the second port 850 to the fourth port 855. As discussed, the choice of services between the chosen origin port(s) to destination port(s) associated with the chosen origin port(s) can depend on a need to optimize time(s), cost(s), emissions, or some combination thereof. As also discussed, the choice of destination port(s) can depend on a need to optimize time(s), cost(s), emissions, or some combination thereof.

At the destination port(s) associated with the chosen origin port(s), containers can be removed from railcars and/or ships. In railway implementations, containers can be removed from railcars using rail ramps at the third port 845 or the fourth port 855. In shipping implementations, containers can be removed from ships using shipping ramps at the third port 845 or the fourth port 855. Tariffs and rates can also be reassessed at the destination port(s). Once removed from railcars and/or ships, containers can be transported to the goods unloading area 860 using trucks.

In some implementations, the number of trucks used to carry containers to the goods unloading area 860 is optimized based on the time(s), costs(s), and emission(s) required to transport the goods between the destination port(s) and the goods unloading area 860. The capacity of trucks used to carry containers to the goods unloading area 860 can also be optimized based on the time(s), costs(s), and emission(s) required to transport the goods between the destination port(s) and the goods unloading area 860. The loading time of trucks can also be optimized based on the time(s), costs(s), and emission(s) required to transport the goods between the destination port(s) and the goods unloading area 860.

The goods can be unloaded from containers at the goods unloading area 860. The goods can be transported to drop off locations (e.g., the first drop off location 865 or the second drop off location 870). In a specific implementation, the number of trucks used to carry the goods to the drop off locations is optimized based on the time(s), costs(s), and emission(s) required to transport the goods between the destination port(s) and the goods unloading area 860. The capacity of trucks used to carry goods to the drop off locations can also be optimized based on the time(s), costs(s), and emission(s) required to transport the goods between the destination port(s) and the goods unloading area 860. The loading time of trucks can also be optimized based on the time(s), costs(s), and emission(s) required to transport the goods between the destination port(s) and the goods unloading area 860.

Empty containers can be transported to container providers, such as the third container provider 830 and the fourth container provider 835. In a specific implementation, the number of trucks used to carry the containers to the container providers is optimized based on the time(s), costs(s), and emission(s) required to transport the goods between the destination port(s) and the goods unloading area 860. The capacity of trucks used to carry containers to the container providers can also be optimized based on the time(s), costs(s), and emission(s) required to transport the goods between the destination port(s) and the goods unloading area 860. The loading time of trucks can also be optimized based on the time(s), costs(s), and emission(s) required to transport the goods between the destination port(s) and the goods unloading area 860.

Trucks loaded with goods can be received at the drop off locations (e.g., the first drop off location 856 and the second drop off location 870). The trucks can include full trucks, LTL trucks, etc.

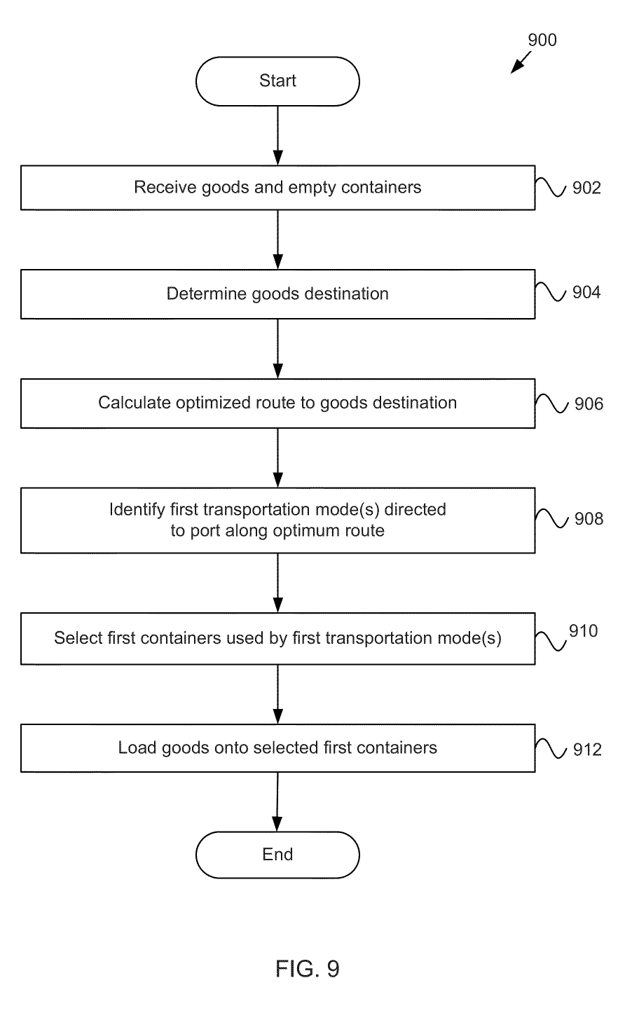

FIG. 9 shows an example of a flowchart 900 of a method for sending goods from an input door to a port along an optimized route. At block 902, goods and empty containers may be received. At block 904, a goods destination may be determined. At block 906, an optimized route to the goods destination may be determined. The optimized route may be based on time, cost, emissions, and/or some combination thereof. The optimized route may be based on a sliding scale of time, cost, and/or emissions. At block 908, one or more first transportation modes directed to a port along the optimized route are determined. At block 910, first containers used by the one or more first transportation modes are selected. At block 912, the goods are loaded onto the selected first containers.

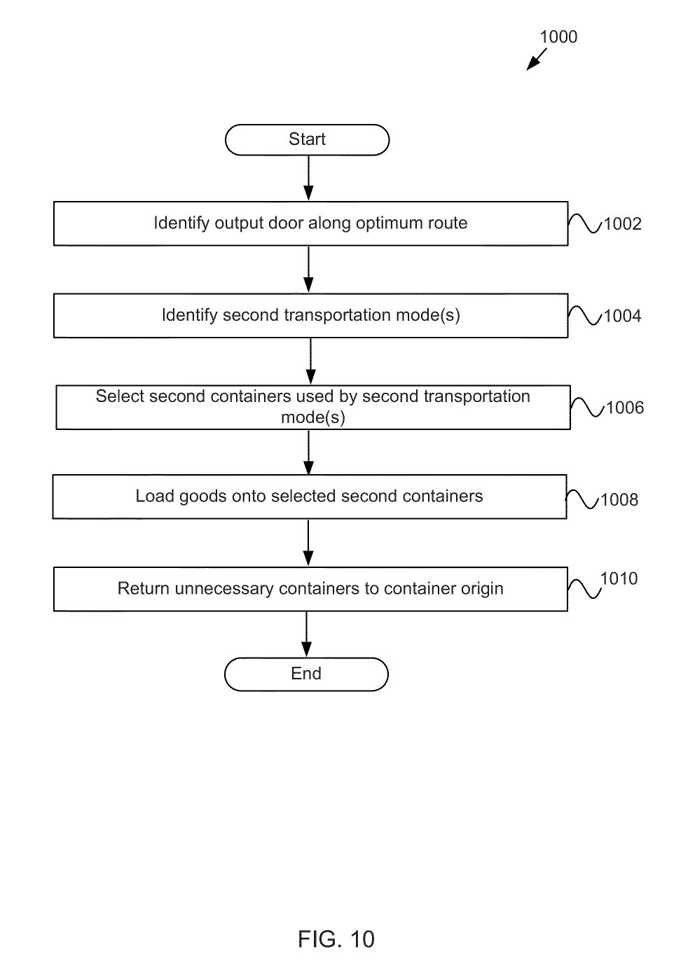

FIG. 10 shows an example of a flowchart of a method for sending goods from a port to an output door along an optimized route. At block 1002, an output door along the optimized route is identified. At block 1004, one or more second transportation modes are identified. At block 1006, second containers used by the one or more second transportation modes are selected. At block 1008, goods are loaded onto the selected second containers. At block 1010, unnecessary containers are returned to the container origin.

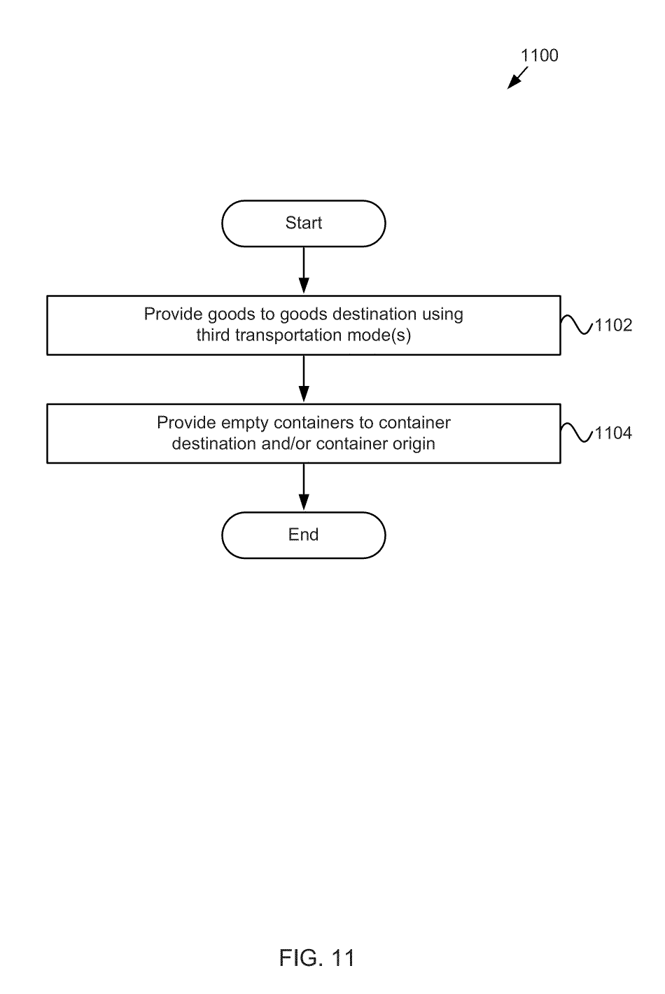

FIG. 11 shows an example of a flowchart of a method for sending goods to a goods destination. At block 1102, goods are provided to the goods destination using one or more third transportation modes. At block 1104, empty containers are provide to the container destination and/or the container origin.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

1. A system comprising a processor, a memory and program code which, when executed by the processor, configures the system to:
(a) receive a search query comprising an origin, a destination, a description of goods to be transported from the origin to the destination, and a desired time for the transportation;
(b) using the search query, search a database comprising information regarding (i) one or more origin vendors providing truck service from the origin to a first rail ramp, (ii) one or more rail vendors providing rail service from the first rail ramp to a second rail ramp, (iii) one or more destination vendors providing truck service from the second rail ramp to the destination, and (iv) one or more container providers providing empty containers at a first location acceptable for at least one of the origin vendors to pick up and accepting empty containers at a second location acceptable for at least one of the destination vendors to drop off, wherein:
the containers are suitable for the goods, and
each of the origin vendors, the rail vendors, the destination vendors and the container providers is available to provide service or container during the desired time and has a quoted price for such service or container;
(c) identify one or more itineraries each comprising a container provider, an origin vendor, a rail vendor and a destination vendor that collectively are able to transport the goods from the origin to the destination; and
(d) calculate a total quoted price for each of the itineraries taking the quoted prices from each of the container provider, the origin vendor, the rail vendor and the destination vendor as input.

2. The system of claim 1, wherein the code further configures the system to (e) determine an optimal total quoted price and an optimal itinerary.

3. The system of claim 1, wherein the code further configures the system to calculate the quoted price for each of the origin vendors for each itinerary, which calculation takes as input a size of the container, a distance between the origin and the first ramp and a distance between the first location and the origin.

4. The system of claim 3, wherein the calculation further takes as input at least one of i) a distance between the origin vendor and the first location and ii) a distance between the first ramp and the origin vendor.

5. The system of claim 1, wherein the code further configures the system to calculate the quoted price for each of the destination vendors for each itinerary, which calculation takes as input a size of the container, a distance between the second ramp and the destination, and a distance between the destination and the second location.

6. The system of claim 5, wherein the calculation further takes as input at least one of i) a distance between the destination vendor and the second ramp and ii) a distance between the second location and the destination vendor.

7. The system of claim 1, wherein the second location is at the second ramp.

8. The system of claim 1, wherein the calculation in (d) further takes as input an incentive provided by an equipment vendor for the second location.

9. The system of claim 2, wherein the optimal total quoted price is within a range defined by the lowest five total quoted prices.

10. The system of claim 2, wherein the optimal total quoted price is within a range defined by the lowest three total quoted prices.

11. The system of claim 2, wherein the code further configures the system to calculate a margin as the difference between the total quoted price of each itinerary and the optimal total quoted price.

12. The system of claim 11, wherein the optimal itinerary is selected as the itinerary with the highest margin.

13. A computing device comprising a processor, a memory, and program code which, when executed by the processor, configures the device to:
(a) receive an input from a user, which input comprises an origin location, a destination location, a description of goods to be transported from the origin location to the destination location, and a desired time for the transportation;
(b) display a list of at least one quoted price for providing the transportation from the origin location to the destination location; and
(c) receive a command from the user as to whether to accept the quoted price.

14. The device of claim 13, wherein the code further configures the device to:
use the input to search a database comprising information regarding (i) one or more origin vendors providing truck service from the origin location to a first rail ramp, (ii) one or more rail vendors providing rail service from the first rail ramp to a second rail ramp, (iii) one or more destination vendors providing truck service from the second rail ramp to the destination location, and (iv) one or more container providers providing empty containers at a first location acceptable for at least one of the origin vendors to pick up and accepting empty containers at a second location acceptable for at least one of the destination vendors to drop off, wherein the containers are suitable for the goods, each of the origin vendors, the rail vendors, the destination vendors and the container providers is available to provide service or container during the desired time and has a quoted price for such service or container;
identify one or more itineraries each comprising a container provider, an origin vendor, a rail vendor and a destination vendor that collectively are able to transport the goods from the origin location to the destination location; and
calculate a total quoted price for each of the itineraries taking the quoted prices from each of the container provider, the origin vendor, the rail vendor and the destination vendor as input.

15. A system comprising:
a first modular container transport operating in accordance with a first modular container transport system;
a second modular container transport operating in accordance with a second modular container transport system;
a third modular container transport, distinct from the first modular container transport, operating in accordance with a third modular container transport system;
a fourth modular container transport operating in accordance with a fourth modular container transport system;
a fifth modular container transport, distinct from the first modular container transport and the third modular container transport, operating in accordance with a fifth modular container transport system;
a first node operationally connecting the first modular container transport system, the second modular container transport system, and the third modular container transport system, wherein the first node has a first associated cost and a first associated time frame having a start time;
a second node operationally connecting the third modular container transport system, the fourth modular container transport system, and the fifth modular container transport system, wherein the second node has a third associated cost and a third associated time frame having an end time; wherein an edge between the first node and the second node over which the third modular container transport system operates is associated with a second associated cost and a transit time, wherein the start time plus the transit time is less than or equal to the end time;
a route and rate determination system configured to: receive cargo transport parameters, match an origin of the cargo transport parameters to the first modular container transport within the first associated time frame, match the second modular container transport to the first node before the start time, match the third modular container transport to the first node within the first associated time frame and to the second node within the third associated time frame, match the fourth modular container transport to the second node before the end time, and match the fifth modular container transport to the second node within the third associated time frame;
wherein, in operation:
the route and rate determination system determines an itinerary comprising a container provider, an origin, a transport vendor, and a destination vendor, wherein the itinerary has an associated cost that is a sum of quoted costs associated with the container provider, the origin vendor, the transport vendor, and the destination vendor, and wherein the itinerary requires the first modular container transport be instructed by the first modular container transport system to obtain a container from the container provider for transporting goods from the origin to the first node and drop off the container within the first associated time frame, the third modular container transport be instructed by the third modular container transport system to pick up at the first node within the first associated time frame and deliver to the second node within the third associated time frame the container with the goods, and the fifth modular container transport be instructed by the fifth modular container transport system to pick up at the second node and deliver to a destination the container with the goods;
the first modular container transport transports from the origin to the first node goods associated with the cargo transport parameters in a container suitable for transport of the goods and suitable for transport at least by the first modular container transport, the third modular container transport, and the fifth modular container transport;
the second modular container transport transports to the first node a first empty modular container for pick up by the first modular container transport after the first modular container transport drops off the container with the goods;
the third modular container transport transports the container with the goods from the first node to the second node;
the fourth modular container transport transports a second empty modular container for pick up by the third modular container transport after the third modular container transport drops off the container with the goods;
the fifth modular container transport transports the container with the goods from the second node to a destination.

16. The system of claim 15, wherein the first modular container transport system and the second modular container transport system are the same system.

17. The system of claim 15, wherein the fourth modular container transport system and the fifth modular container transport system are the same system.

18. The system of claim 15, wherein, in operation, the first modular container transport picks up the first empty modular container and transports the first empty modular container to the origin where the goods are put into the first empty modular container to create the container with the goods.

19. The system of claim 15, wherein the fifth modular transport is the fourth modular transport, wherein, in operation, the fourth modular transport delivers the second empty modular container prior to picking up the container with the goods.

20. A system comprising:
a transportation management engine configured to provide possible transportation modes for transporting a good from a goods origin to a goods destination;
a rate management engine configured to identify a rate associated with the good using the one or more transportation modes;
a route optimization engine configured to:
identify an optimized route between the goods origin and the goods destination, the optimized route comprising a first door associated with the goods origin and a second door associated with the goods destination;
select one or more of the possible transportation modes for the good between the first door and the second door, the selecting based on the optimized route.

21. The system of claim 20, wherein the optimized route comprises a port between the first door and the second door.

22. The system of claim 20, wherein the optimized route comprises a port between the first door and the second door, and selecting one or more of the possible transportation modes for the good comprises selecting a first transportation mode for the good between the first door and the port, and selecting a second transportation mode for the good between the port and the second door.

23. The system of claim 20, wherein the good is transported in a container, the container being loaded with the good at the first door.

24. The system of claim 20, wherein the optimized route comprises a port between the first door and the second door,

25. The system of claim 20, wherein the route optimization engine is configured to identify the optimized route using an optimization algorithm based at least in part on minimizing a transportation time between the first door and the second door.

26. The system of claim 20, wherein the route optimization engine is configured to identify the optimized route using an optimization algorithm based at least in part on minimizing a transportation cost between the first door and the second door.

27. The system of claim 20, wherein the route optimization engine is configured to identify the optimized route using an optimization algorithm based at least in part on minimizing a transportation emission between the first door and the second door.

28. The system of claim 20, wherein the route optimization engine is configured to identify the optimized route using an optimization algorithm based at least in part on minimizing at least two of a transportation time, a transportation cost, and a transportation emission between the first door and the second door.

29. The system of claim 28, wherein the optimization algorithm uses a sliding scale based on the transportation time, the transportation cost, and the transportation emission.

30. A method comprising:
providing possible transportation modes for transporting a good from a goods origin to a goods destination;
identifying a rate associated with the good using the one or more transportation modes;
identifying an optimized route between the goods origin and the goods destination, the optimized route comprising a first door associated with the goods origin and a second door associated with the goods destination;
selecting one or more of the possible transportation modes for the good between the first door and the second door, the selecting based on the optimized route.

31. The method of claim 30, wherein the optimized route comprises a port between the first door and the second door.

32. The method of claim 30, wherein the optimized route comprises a port between the first door and the second door, and selecting one or more of the possible transportation modes for the good comprises selecting a first transportation mode for the good between the first door and the port, and selecting a second transportation mode for the good between the port and the second door.

33. The method of claim 30, wherein the good is transported in a container, the container being loaded with the good at the first door.

34. The method of claim 30, wherein the optimized route comprises a port between the first door and the second door,

35. The method of claim 30, wherein identifying the optimized route comprises using an optimization algorithm based at least in part on minimizing a transportation time between the first door and the second door.

36. The method of claim 30, wherein identifying the optimized route comprises using an optimization algorithm based at least in part on minimizing a transportation cost between the first door and the second door.

37. The method of claim 30, wherein identifying the optimized route comprises using an optimization algorithm based at least in part on minimizing a transportation emission between the first door and the second door.

38. The method of claim 30, wherein identifying the optimized route comprises using an optimization algorithm based at least in part on minimizing at least two of a transportation time, a transportation cost, and a transportation emission between the first door and the second door.

39. The method of claim 38, wherein the optimization algorithm uses a sliding scale based on the transportation time, the transportation cost, and the transportation emission.
